(19) United States
(12) Patent Application Publication
(10) Pub. No.: US 2022/0201028 A1
(43) Pub. Date: Jun. 23, 2022

(54) CAUTION-NEEDED IP ADDRESS ESTIMATION APPARATUS, MONITORING SYSTEM, CAUTION-NEEDED IP ADDRESS PROVIDING METHOD AND PROGRAM

(71) Applicant: Nippon Telegraph and Telephone Corporation, Tokyo (JP)

(72) Inventor: Masaru Sanada, Musashino-shi, Tokyo (JP)

(21) Appl. No.: 17/606,964

(22) PCT Filed: May 17, 2019
(86) PCT No.: PCT/JP2019/019779

§ 371 Date: Oct. 28, 2021

(51) Int. Cl. H04L 9/40

(52) U.S. Cl. CPC H04L 63/1425; H04L 61/1511

(57) ABSTRACT

A caution-needed IP address estimation device includes: acquisition means for acquiring, based on a degree of exposure of a subject covered by mass media, an IP address that is associated with the subject, the IP address serving as a caution-needed IP address; and transmission means for transmitting the caution-needed IP address to a NW monitoring information database device.

### TECHNICAL FIELD

The present invention relates to a technique for monitoring traffic in a network.

### BACKGROUND ART

Once companies, organizations, individuals, and so on are covered by the mass media and the exposure to the public increases, the interests of ordinary people or attackers will be attracted, and the number of accesses to relevant websites tends to increase.

With this, not only the relevant websites but also the communication network are affected due to an increase in processing load, for example. In order to prevent such an adverse effect from occurring in the communication network or resolve such an adverse effect when it is still small, there is a demand for detecting an increase in processing load as early as possible.

To detect an increase in processing load, for example, monitoring traffic based on an IP address as disclosed in PTL 1 is conceivable.

### CITATION LIST

### Patent Literature

[PTL 1] JP 2017-130037A

### SUMMARY OF THE INVENTION

### Technical Problem

However, PTL 1 does not disclose how to acquire the IP address used to monitor traffic. It is conceivable that an IP address to be monitored is set by an operator or the like, but if an operator is used, it takes time and effort with manpower, and detection of an increase in processing load may occur late.

The present invention has been made in view of the above-described circumstances, and an object thereof is to provide a technique for enabling automatic acquisition of an IP address of a subject that is likely to affect a network.

### Means for Solving the Problem

According to the disclosed technique, a caution-needed IP address estimation device is provided that includes:

acquisition means for acquiring, based on a degree of exposure of a subject covered by mass media, an IP address that is associated with the subject, the IP address serving as a caution-needed IP address; and

transmission means for transmitting the caution-needed IP address to a NW monitoring information database device.

### Effects of the Invention

According to the disclosed technique, it is possible to automatically acquire an IP address of a subject that is likely to affect a network.

### BRIEF DESCRIPTION OF DRAWINGS

FIG. 1 is a diagram illustrating an example of a system configuration according to an embodiment of the present invention.

FIG. 2 are diagrams for illustrating a function of a NW monitoring information DB 500.

FIG. 3 is a diagram illustrating an example of a network configuration.

FIG. 4 is a diagram for illustrating examples of security measures.

FIG. 5 is a diagram illustrating an example of a functional configuration of a caution-needed IP address estimation device 100.

FIG. 6 is a diagram illustrating an example of a device hardware configuration.

FIG. 7 is a diagram illustrating an example of a processing flow of the caution-needed IP address estimation device 10.

FIG. 8 is a diagram illustrating an example of a processing flow of the NW monitoring information DB 500.

FIG. 9 is a diagram illustrating an example of the processing flow of the NW monitoring information DB 500.

FIG. 10 is a diagram illustrating an example of a processing flow of network security monitoring devices 700.

FIG. 11 is a diagram illustrating an example of the processing flow of the network security monitoring devices 700.

FIG. 12 is a diagram illustrating an example of the processing flow of the network security monitoring devices 700.

### DESCRIPTION OF EMBODIMENTS

Hereinafter, an embodiment (present embodiment) of the present invention will be described with reference to the drawings. The present embodiment described below is merely an example, and the embodiment to which the present invention is applied is not limited to the following embodiment.

In the present embodiment, a monitoring system will be described that deals with unexpectedly published mass media information, automatically extracts a caution-needed IP address, and sets this caution-needed IP address in a network. The caution-needed IP address is dynamically updated periodically. Hereinafter, the configuration and operation of the monitoring system will be described in detail.

(System Configuration)

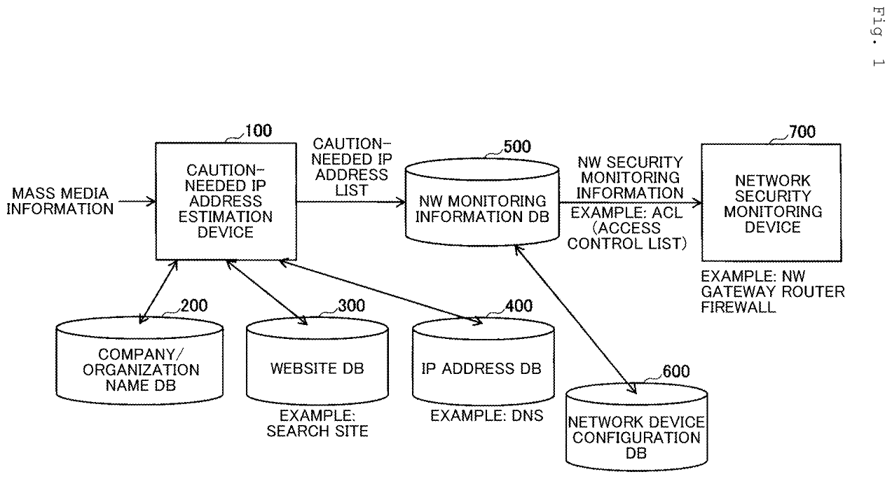

FIG. 1 shows an example of a configuration of the monitoring system according to the present embodiment. As shown in FIG. 1, the monitoring system according to the present embodiment includes a caution-needed IP address estimation device 100, a company/organization name DB (database) 200, a website DB 300, an IP address DB 400, a NW monitoring information DB 500, a network device configuration DB 600, and a network security monitoring device 700. Each of the devices are capable of communicating with another device as shown in FIG. 1. Overviews of the functions of the respective devices are as follows.

The caution-needed IP address estimation device 100 generates a caution-needed IP address list with reference to the company/organization name DB 200, the website DB 300, and the IP address DB 400 based on mass media information, and transmits the caution-needed IP address list to the NW monitoring information DB 500.

The company/organization name DB 200 is a database device in which the names of actual companies and organizations are stored. The website DB 300 is a database device in which the website names of companies and organizations are stored. The website DB 300 may be a search site. The IP address DB 400 is a database device in which the website names and IP addresses are stored in association with each other. The IP address DB 400 may be a DNS.

The NW monitoring information DB 500 generates NW security monitoring information, and transmits the generated NW security monitoring information to the network security monitoring device 700. The NW security monitoring information is an ACL (access control list), for example.

The network device configuration DB 600 is a database device in which individual conditions and the like of each network security monitoring device 700 are stored. The network security monitoring device 700 is a network security monitoring device attached to a packet forwarding device (e.g., a router). The network security monitoring device 700 attached to a packet forwarding device may refer to a network security monitoring device 700 connected to the packet forwarding device, or may refer to a network security monitoring function that is one of the functions of the packet forwarding device.

The network security monitoring device 700 attached to a packet forwarding device is, for example, a firewall function of a NW gateway router with a firewall function.

(Regarding NW Monitoring Information DB 500)

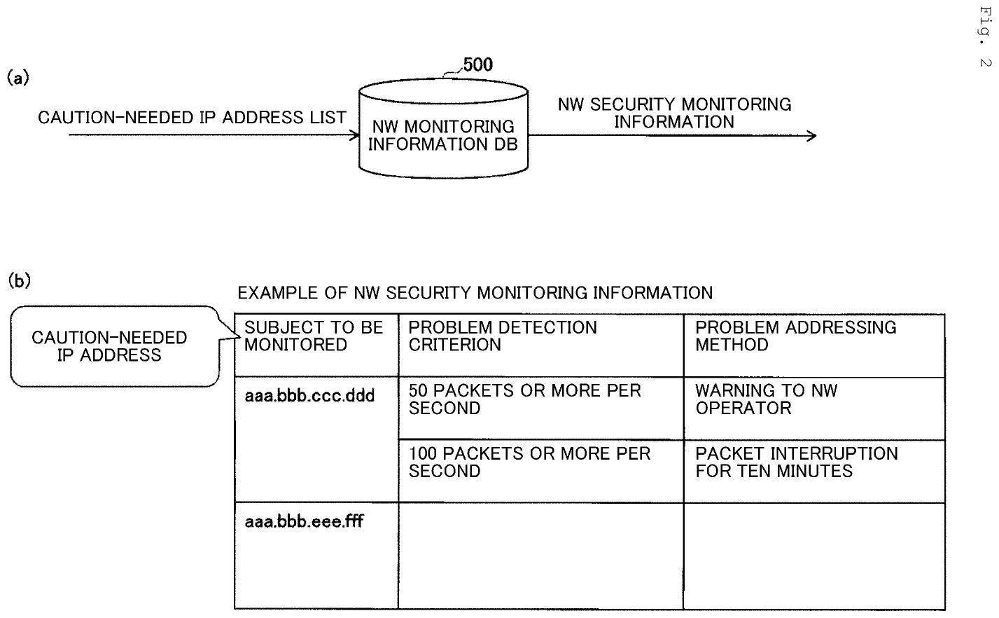

As shown in FIGS. 2(a) and 2(b), the NW monitoring information DB 500 receives the caution-needed IP address list from the caution-needed IP address estimation device 100, and defines, for each caution-needed IP address, a problem detection criterion and a problem addressing method (that may be referred to also as security measure information). Furthermore, the NW monitoring information DB 500 transmits and sets these pieces of information serving as NW security monitoring information to the network security monitoring device 700.

Note that the NW monitoring information DB 500 may set, as the NW security monitoring information, different type of information for each network security monitoring device 700.

(Regarding Network Configuration)

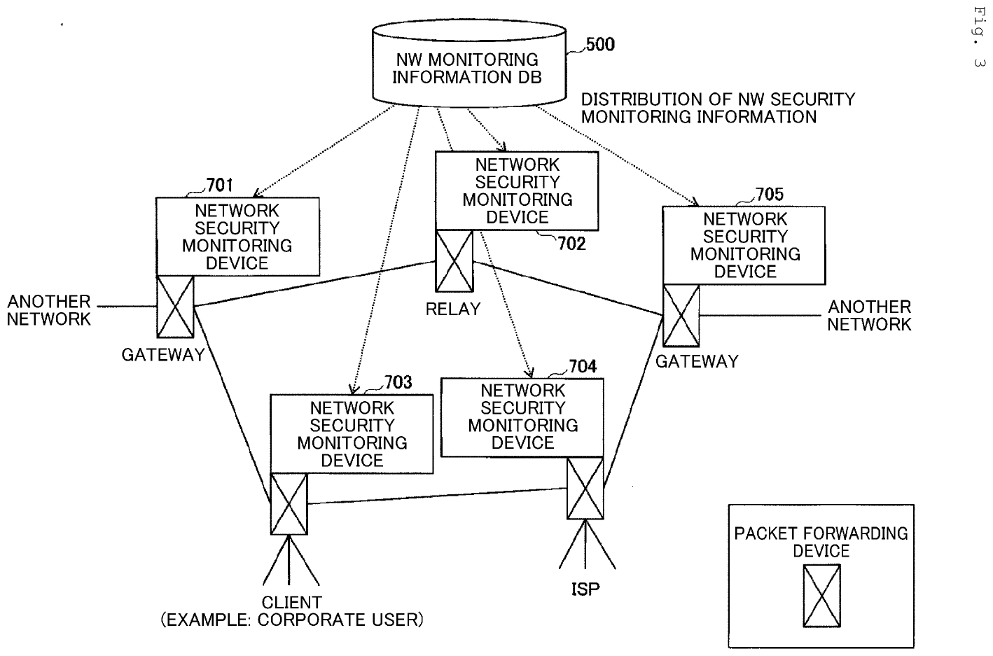

FIG. 3 shows an example of a network configuration to which the NW security monitoring information is to be distributed from the NW monitoring information DB 500. In the example of FIG. 3, network security monitoring devices 701 and 705, a network security monitoring device 702, a network security monitoring device 703, and a network security monitoring device 704 are shown. The network security monitoring devices 701 and 705 are attached to a gateway packet forwarding device. The network security monitoring device 702 is attached to a relay packet forwarding device. The network security monitoring device 703 is attached to a client packet forwarding device. The network security monitoring device 704 is attached to an ISP packet forwarding device.

The network security monitoring devices 700 may have different conditions for traffic to be monitored according to the configuration of the corresponding packet forwarding device. With this, the NW security monitoring information to be set may be different from each other.

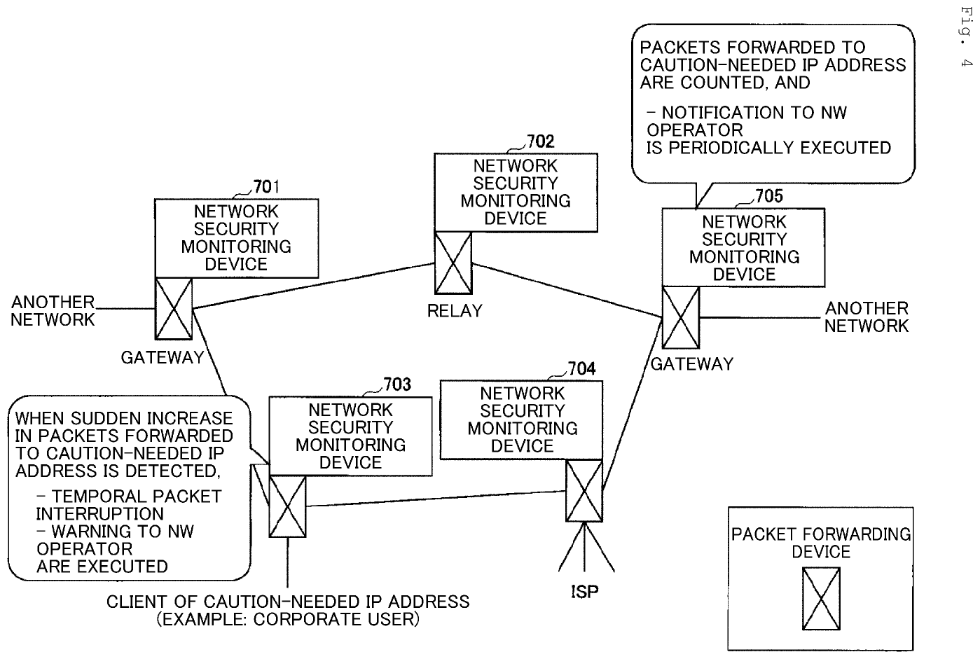

FIG. 4 shows examples of NW security monitoring operations. FIG. 4 also shows an example in which the security measurement methods are different from each other between the packet forwarding devices. In the example shown in FIG. 4, the network security monitoring device 705 counts packets forwarded to a caution-needed IP address, and periodically performs notification to the NW operator. On the other hand, the network security monitoring device 703 executes, upon detecting a sudden increase in packets forwarded to a caution-needed IP address, temporal packet interruption and warning to the NW operator. Such operations can be realized when different types of NW security monitoring information are set for the respective network security monitoring devices corresponding to the packet forwarding devices.

(Configuration and Operation of Caution-Needed IP Address Estimation Device 100)

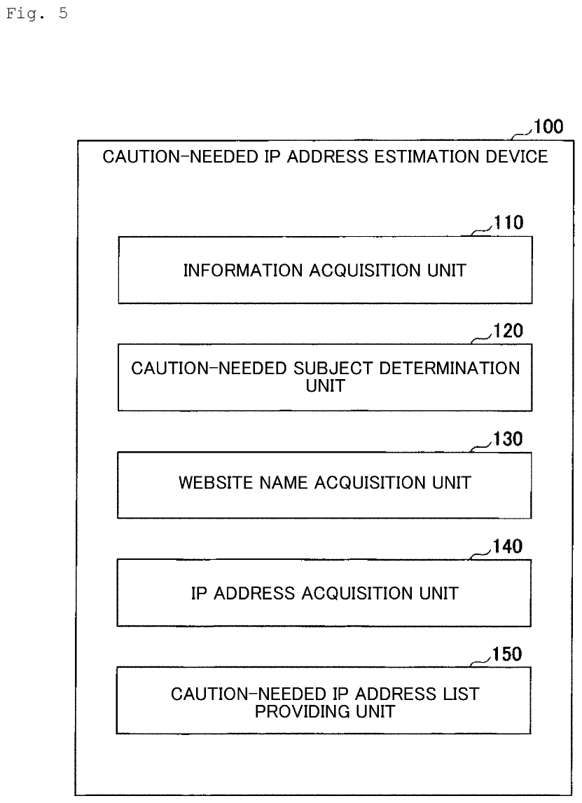

FIG. 5 is a diagram illustrating an example of a functional configuration of the caution-needed IP address estimation device 100. As shown in FIG. 5, the caution-needed IP address estimation device 100 includes an information acquisition unit 110, a caution-needed subject determination unit 120, a website name acquisition unit 130, an IP address acquisition unit 140, and a caution-needed IP address list providing unit 150. The operation procedures of these functional units are as follows.

First, the information acquisition unit 110 acquires mass media information. The mass media information refers to, for example, a newspaper article (text), a TV program guide (text), or the like. With respect to the method for acquiring mass media information, the information acquisition unit 110 may automatically acquire mass media information from a network, or the information acquisition unit 110 may acquire mass media information by reading an image of a newspaper article or the like, and converting the read image into text.

Then, the caution-needed subject determination unit 120 counts the number of times of appearance of national/local public agencies, companies, various types of organizations, and the like based on the mass media information. The national/local public agencies, companies, various types of organization, and the like are examples of subjects to be covered by the mass media. Also, the number of times of appearance is an example of the degree of exposure.

Note that using the number of times of appearance as the degree of exposure is merely an example. The caution-needed subject determination unit 120 determines subjects that appear a large number of times as caution-needed subjects that affect the network, and generates a list of the caution-needed subjects. The subjects that appear a large number of times means, for example, subjects in the top N-th rank of a list in which the names are listed in the descending order from the largest number of times of appearance. N is a preset integer of 1 or greater. Also, subjects that appear a large number of times may be, for example, subjects that appear within a predetermined period of time a certain number of times that exceeds a predetermined threshold. Note that determining a subject that appears a large number of times as a caution-needed subject is merely an example.

Subsequently, the website name acquisition unit 130 acquires the website names of the caution-needed subjects with reference to the website DB 300. Then, the IP address acquisition unit 140 acquires IP addresses based on the website names with reference to the IP address DB 400, and generates a caution-needed IP address list made up of the acquired IP addresses.

The caution-needed IP address list providing unit 150 transmits the caution-needed IP address list to the NW monitoring information DB 500.

With the above-described processing, it is possible to extract, from mass media information, the IP addresses that may attract the interests of ordinary people or attackers and may affect a network, specifically and automatically.

(Example of Setting and Utilization of Caution-Needed IP Addresses)

The NW monitoring information DB 500 that has received the caution-needed IP address list generate NW security monitoring information by, for example, merging the caution-needed IP address list with another monitoring information. As shown in FIG. 2(b) for example, by merging the caution-needed IP address list with the problem detection criterion/problem addressing method, the NW security monitoring information is generated.

The NW monitoring information DB 500 transmits and sets the generated NW security monitoring information to the network security monitoring device 700. The network security monitoring device 700 monitors abnormal traffic based on the set NW security monitoring information.

(Example of Hardware Configuration of Device)

The devices of the present embodiment such as the caution-needed IP address estimation device 100, the NW monitoring information DB 500, and the network security monitoring device 700 can be realized by causing a computer to execute a program that describes processing content of the present embodiment, for example.

Each of the devices can be realized by a program that corresponds to the processing executed in this device being executed using a hardware resources such as a CPU and a memory that are built in the computer. The program can be recorded in a computer-readable recording medium (portable memory or the like), so as to be saved or distributed. Also, the program can be provided via the Internet or an E-mail, that is, via a network.

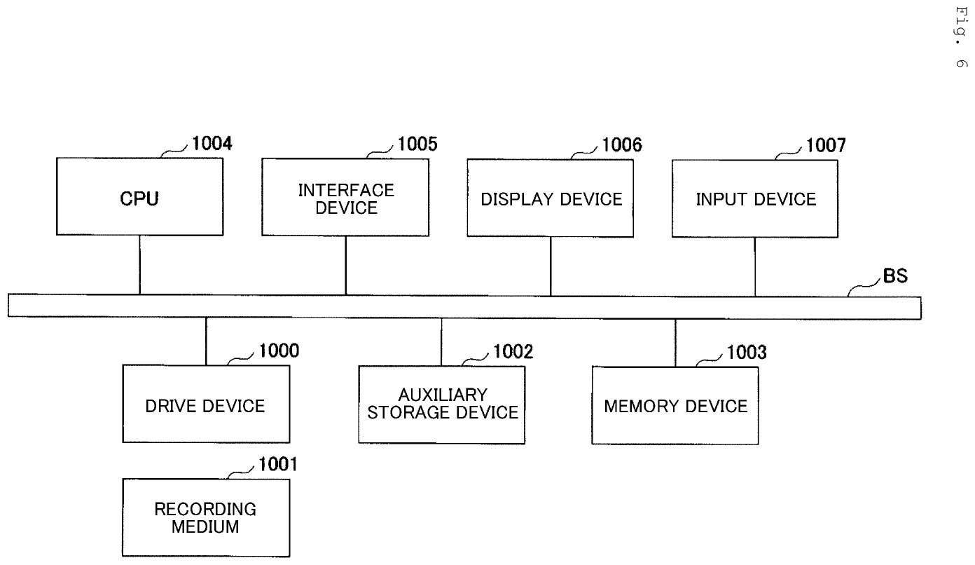

FIG. 6 is a diagram illustrating an example of a hardware configuration of the computer according to the present embodiment. The computer shown in FIG. 6 includes a drive device 1000, an auxiliary storage device 1002, a memory device 1003, a CPU 1004, an interface device 1005, a display device 1006, an input device 1007, and the like that are mutually connected to each other via a bus B.

The program with which the processing of the computer is realized is provided via a recording medium 1001 such as, for example, a CD-ROM or a memory card. When the recording medium 1001 in which the program is recorded is set in the drive device 1000, the program is installed from the recording medium 1001 into the auxiliary storage device 1002 via the drive device 1000. Note however that the install of the program is not necessarily performed from the recording medium 1001, and may also be downloaded from another computer via a network. The auxiliary storage device 1002 stores the installed program, and stores required files, data, and the like.

Upon being instructed to start the program, the memory device 1003 reads and stores the program from the auxiliary storage device 1002. The CPU 1004 realizes the functions of the corresponding device in accordance with the program stored in the memory device 1003. The interface device 1005 is used as an interface for connecting to a network. The display device 1006 displays, for example, a GUI (Graphical User Interface) by the program. The input device 1007 is constituted by a keyboard and a mouse, buttons or a touch panel, for example, and is used for a user to input various operation instructions.

(Example of Processing Flow)

The following will describe examples of processing flows as examples of detailed operations with respect to the caution-needed IP address estimation device 100, the NW monitoring information DB 500, and the network security monitoring devices 700.

<Example of Processing Flow of Caution-Needed IP Address Estimation Device 100>

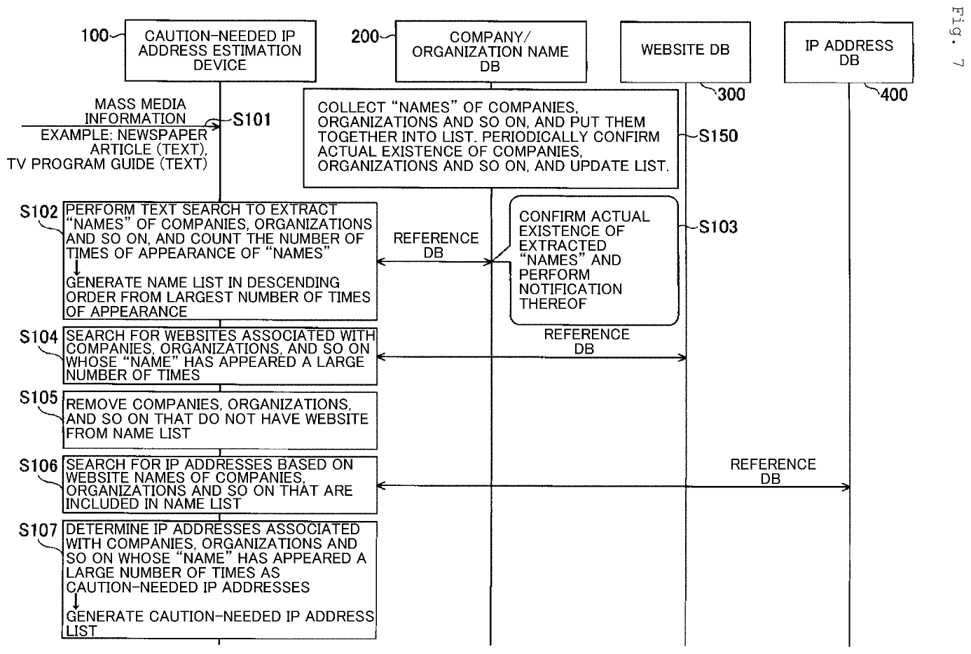

An example of a processing flow of the caution-needed IP address estimation device 100 will be described with reference to FIG. 7. In step S101, the caution-needed IP address estimation device 100 acquires mass media information. The mass media information is, for example, a newspaper article (text), a TV program guide (text), or the like.

As indicated as step S150, the company/organization name DB 200 collects the “names” of companies, organizations, and so on, and puts them together into a list. Also, the company/organization name DB 200 periodically confirms the actual existence of the companies, organizations, and so on, and updates the list.

In steps S102 and S103, the caution-needed IP address estimation device 100 perform text search in the mass media information to extract the “names” of companies, organizations, and so on, and confirms the actual existence of the extracted “names” with reference to the company/organization name DB 200. Also, the caution-needed IP address estimation device 100 counts the number of times of appearance of the “names” that exist actually, and generates a list in which the names are listed in the descending order from the largest number of times of appearance.

In step S104, the caution-needed IP address estimation device 100 searches for websites associated with the companies, organizations, and so on whose “name” has appeared a large number of times. In step S105, the names of the companies, organizations, and so on that do not have a web site are removed from the name list.

In step S106, the caution-needed IP address estimation device 100 searches for IP addresses based on the website names of the companies, organizations, and so on that are included in the name list with reference to the IP address DB 400, and acquires the IP addresses.

In step S107, the caution-needed IP address estimation device 100 determines the IP addresses associated with the companies, organizations, and so on whose “name” has appeared a larger number of times as caution-needed IP addresses, and generates a caution-needed IP address list that is made up of the caution-needed IP addresses.

The above-described processing content is an example. For example, the following variations are conceivable.

As the mass media information, “trade names” may be used. If “trade names” are used, the caution-needed IP address estimation device 100 extracts names of a plurality of companies based on the “trade names” by performing network search or the like, and counts the names. For example, a manufacture name, a retailer name, a catalog retailer name, and the like can be extracted from a trade name.

A configuration is also possible in which a trade name is extracted from a comment of a popular person in mass media information, and a relevant company name and the like are extracted from the trade name and are counted.

Regarding the counting in step S102, a counting condition may be provided that relates to the release time of the mass media information. For example, it can be defined that the counting is performed only based on information when they appear at the first time in newspaper or the like. Also, it can be defined that the counting is performed based on web site information of newspaper that are accumulated in a predetermined time period.

By performing the counting based on information accumulated in a predetermined time period, it is possible to recognize an increase/decrease in the count. Therefore, the NW measure may be varied such that, for example, when the count has suddenly increased, update of the NW security monitoring information is accelerated or counter measure content is enhanced, and when the count has slowly increased, the frequency of notification of the packet count is increased.

Also, information on Internet services may be used as the mass media information. For example, reputation information on “LINE” (registered trademark) or “Twitter” (registered trademark) may be acquired, a trade name that is much talked about may be acquired from the reputation information, and then a company name and the like may be extracted and counted.

Also, with respect to the extraction of caution-needed IP addresses, a configuration is also possible in which much-talked-about websites are recognized based on access rankings of search sites (search sites are example of mass media), IP addresses are acquired based on the website names, and the acquired IP addresses are defined as caution-needed IP addresses.

A configuration is also possible in which speech content in a smartphone search application or a smart television is acquired from a network using sound recognition, and specific names are extracted from the speech content and are counted.

<Example 1 of Processing Flow of NW Monitoring Information DB 500>

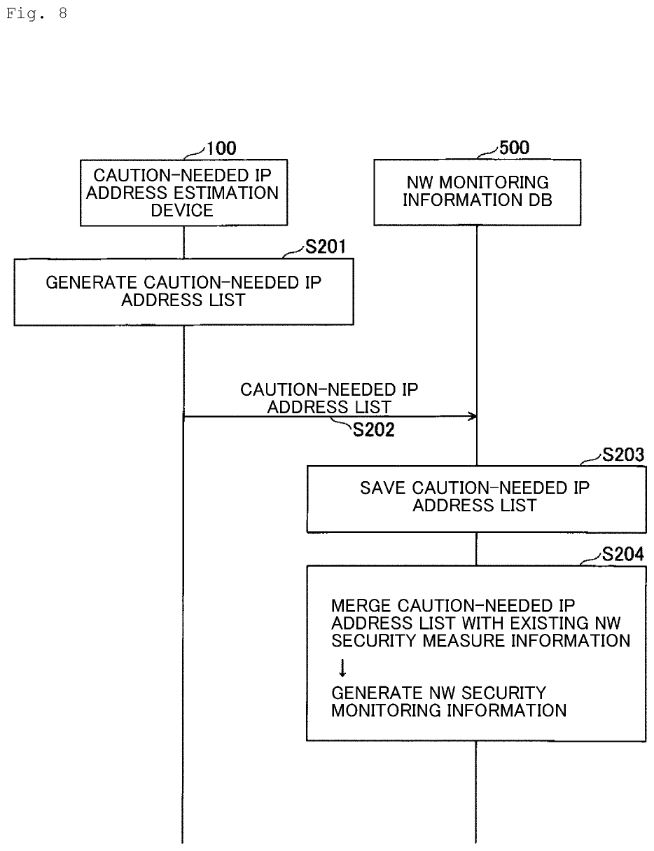

The following will describe an example 1 of a processing flow of the NW monitoring information DB 500 with reference to FIG. 8. The example 1 of the processing flow of the NW monitoring information DB 500 is an example in which the NW monitoring information DB 500 generates only one piece of NW security monitoring information. In other words, in this case, the same NW security monitoring information is set for the network security monitoring devices 700.

In the example of FIG. 8, the NW monitoring information DB 500 has stored therein in advance NW security measure information (such as, for example, the problem detection criterion/problem addressing method shown in FIG. 2(b)).

In steps S201 and S202, the caution-needed IP address estimation device 100 generates a caution-needed IP address list, and transmits the caution-needed IP address list to the NW monitoring information DB 500.

In step S203, the NW monitoring information DB 500 saves the caution-needed IP address list. In step S204, the NW monitoring information DB 500 merges the caution-needed IP address list with the stored existing NW security measure information so as to generate NW security monitoring information.

<Example 2 of Processing Flow of NW Monitoring Information DB 500>

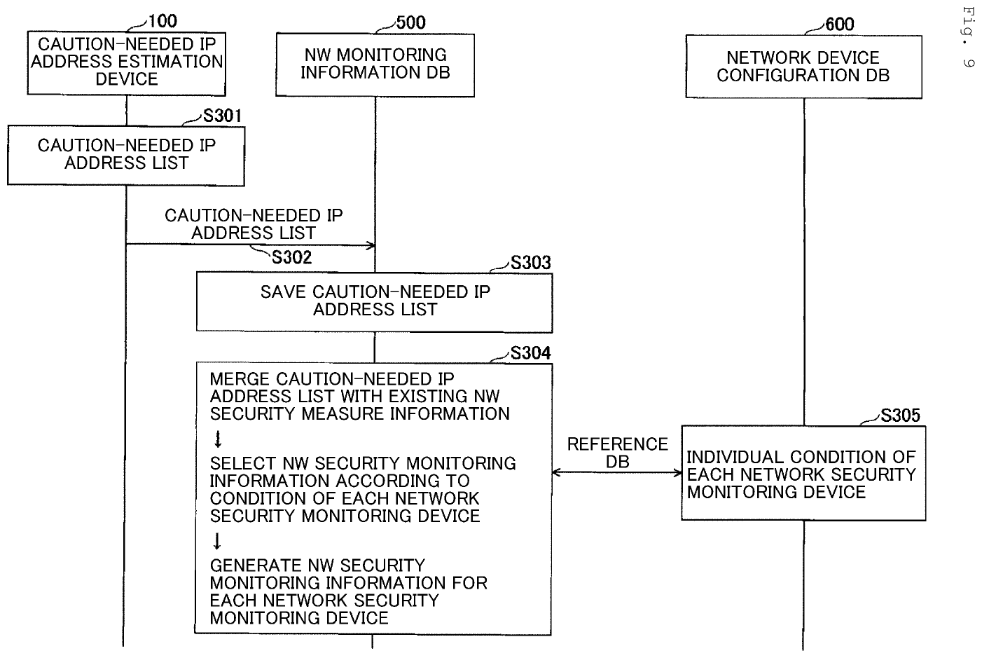

The following will describe an example 2 of a processing flow of the NW monitoring information DB 500 with reference to FIG. 9. The example 2 of the processing flow of the NW monitoring information DB 500 is an example in which the NW monitoring information DB 500 generates different types of NW security monitoring information for the network security monitoring devices 700. In other words, in this case, different type of NW security monitoring information is set for each of the network security monitoring devices 700.

In the example of FIG. 9, the NW monitoring information DB 500 has stored therein in advance NW security measure information.

In steps S301 and S302, the caution-needed IP address estimation device 100 generates a caution-needed IP address list, and transmits the caution-needed IP address list to the NW monitoring information DB 500.

In step S303, the NW monitoring information DB 500 saves the caution-needed IP address list. In step S304, the NW monitoring information DB 500 merges the caution-needed IP address list with the stored existing NW security measure information. Also, the NW monitoring information DB 500 acquires individual conditions of the respective network security monitoring devices from the network device configuration DB 600, and selects NW security monitoring information from information obtained by merging the caution-needed IP address list with the exiting NW security measure information, according to the condition of each network security monitoring device, thereby generating NW security monitoring information for each network security monitoring device.

<Example 1 of Processing Flow of Network Security Monitoring Devices 700>

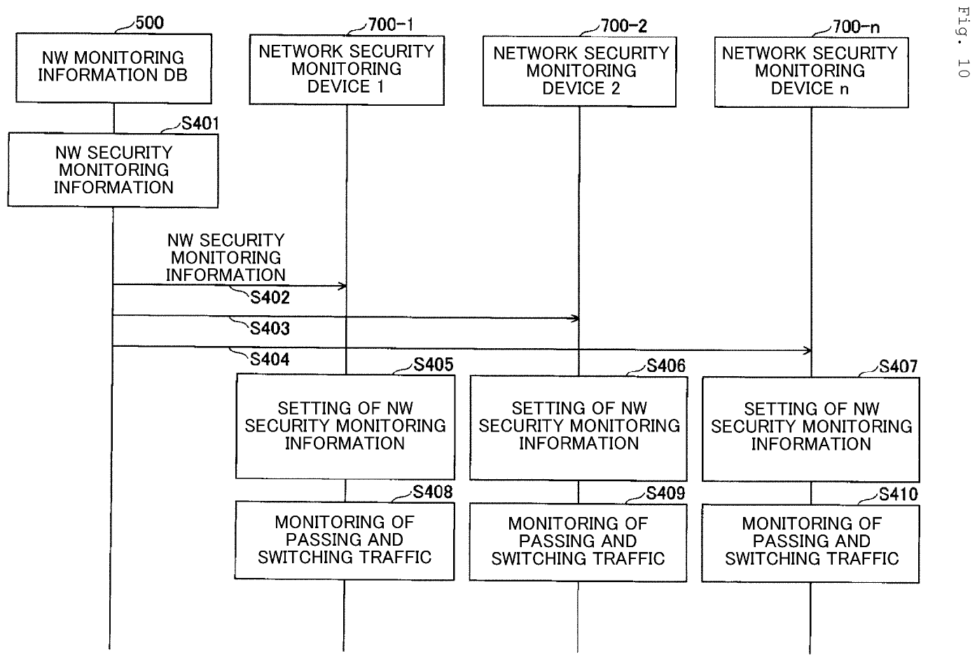

The following will describe an example 1 of a processing flow of the network security monitoring devices 700 with reference to FIG. 10. The example 1 of the processing flow of the network security monitoring devices 700 is an example in which the NW security monitoring information generated by the NW monitoring information DB 500 is uniform, and a plurality of network security monitoring devices 700 set and use the same NW security monitoring information.

In steps S401 and S402 to S404, the NW monitoring information DB 500 generates NW security monitoring information, and transmits the NW security monitoring information to network security monitoring devices 700-1, 700-2, . . . , and 700-n.

The network security monitoring device 700-1 sets the NW security monitoring information, and monitors passing and switching traffic based on the set NW security monitoring information (steps S405 and S408). The other network security monitoring devices 700-2, . . . , and 700-n perform the same processing.

<Example 2 of Processing Flow of Network Security Monitoring Device 700>

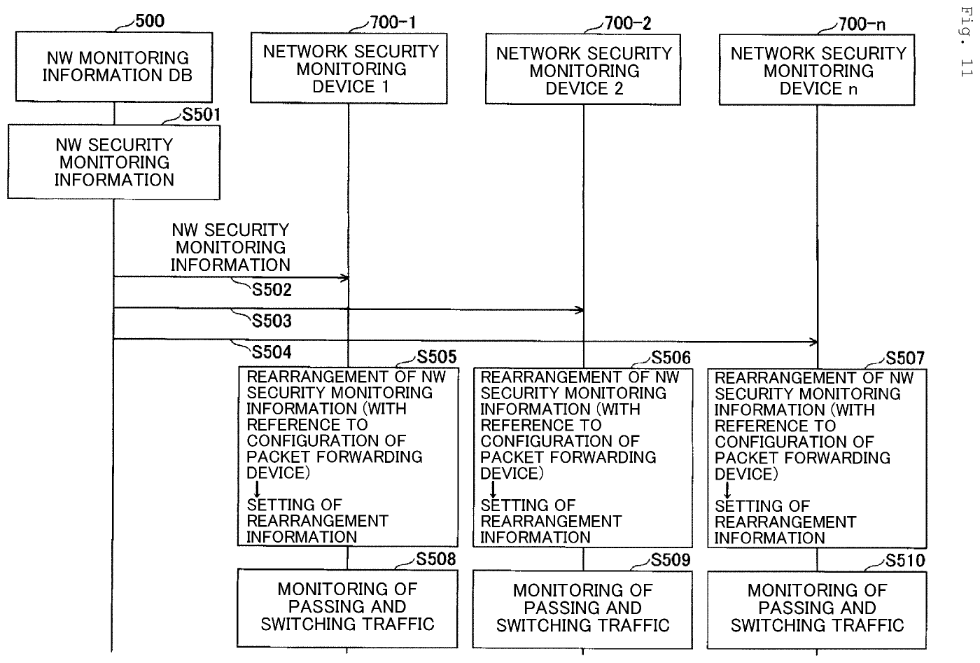

The following will describe an example 2 of a processing flow of the network security monitoring devices 700 with reference to FIG. 11. The example 2 of the processing flow of the network security monitoring devices 700 is an example in which the NW security monitoring information generated by the NW monitoring information DB 500 is uniform, but the NW security monitoring information is rearranged according to the condition of the packet forwarding device in which each of the network security monitoring devices 700 is installed, and the rearranged NW security monitoring information is set and used.

In steps S501 and S502 to S504, the NW monitoring information DB 500 generates NW security monitoring information, and transmits the NW security monitoring information to the network security monitoring devices 700-1, 700-2, . . . , 700-n.

The network security monitoring device 700-1 rearranges the NW security monitoring information with reference to the configuration of the packet forwarding device, sets rearrangement information, and executes monitoring of passing and switching traffic based on the set rearrangement information (steps S505 and S508). The other network security monitoring devices 700-2, . . . , and 700-n perform the same processing.

<Example 3 of Processing Flow of Network Security Monitoring Device 700>

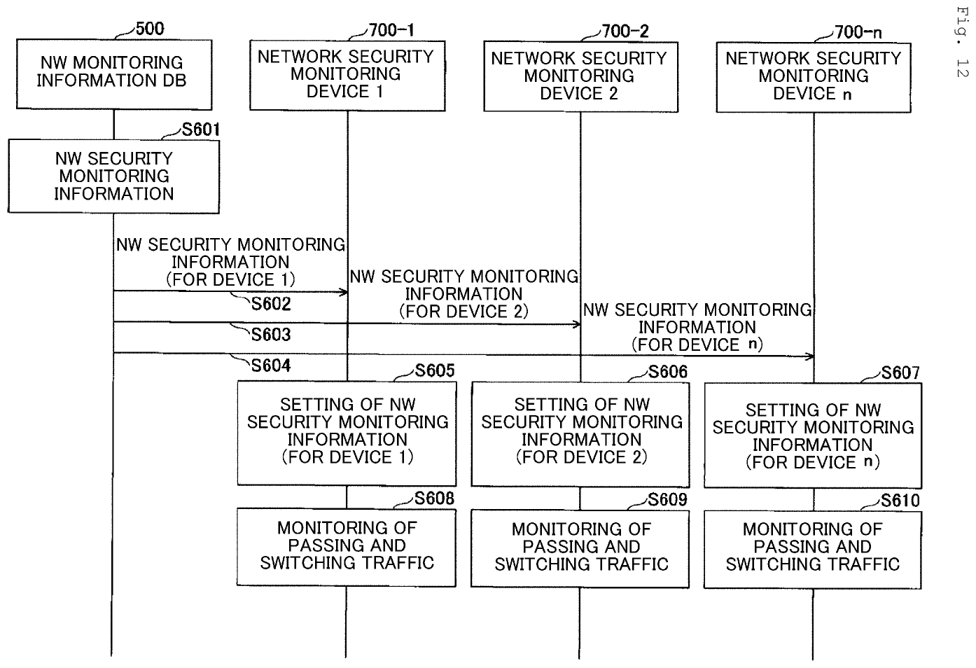

The following will describe an example 3 of a processing flow of the network security monitoring devices 700 with reference to FIG. 12. The example 3 of the processing flow of the network security monitoring devices 700 is an example in which the NW security monitoring information generated by the NW monitoring information DB 500 according to the condition of each of the network security monitoring devices is set for the corresponding network security monitoring device 700, and is used.

In steps S601 and S601 to S604, the NW monitoring information DB 500 generates NW security monitoring information for each of the network security monitoring devices 700. Then, the NW monitoring information DB 500 transmits the NW security monitoring information generated for each of the network security monitoring devices 700 to the corresponding one of the network security monitoring devices 700-1, 700-2, . . . , and 700-n.

The network security monitoring device 700-1 sets the NW security monitoring information dedicated for itself, and executes monitoring of passing and switching traffic (steps S605 and S608). The other network security monitoring devices 700-2, . . . , and 700-n also execute monitoring processing based on the NW security monitoring information dedicated for themselves.

The NW security monitoring information generated for each of the network security monitoring devices 700 corresponds to the state in which different types of NW security monitoring information are set for the network security monitoring devices 703 and 705 shown in FIG. 4, for example.

(Effects of Embodiment)

As described above, in the monitoring system according to the present embodiment, the degrees of exposure of companies, organizations, individuals, and so on are determined based on mass media information, websites as well as IP addresses that are associated therewith are collected, and the IP addresses are monitored on a communication network. Accordingly, an increase in processing load or the like in the communication network due to an increase in access to the websites can be promptly detected, making it possible to prevent an adverse effect from occurring or resolve such an adverse effect when it is still small.

Conventionally, when an event or the like is planned in advance, security measures for the web site of an associated company or the like are manually taken in advance by an operator of the site, but it takes time and effort with manpower because of the manual operation, and the measure may be belated.

On the other hand, with the technique according to the present embodiment, it is possible to deal with unexpectedly published mass media information, automatically extract a caution-needed IP address, and set this caution-needed IP address in a network, thus making it possible to promptly take a measure without requiring time and effort with manpower.

(Summary of Embodiment)

According to the present embodiment, at least a caution-needed IP address estimation device, a monitoring system, a caution-needed IP address providing method, and a program according to the following items are provided.

### (First Item)

A caution-needed IP address estimation device including:

acquisition means for acquiring, based on a degree of exposure of a subject covered by mass media, an IP address that is associated with the subject, the IP address serving as a caution-needed IP address; and

transmission means for transmitting the caution-needed IP address to a NW monitoring information database device.

A portion constituted by the information acquisition unit 110, the caution-needed subject determination unit 120, the website name acquisition unit, and the IP address acquisition unit is an example of the acquisition means. The caution-needed IP address list providing unit 150 is an example of the transmission means.

### (Second Item)

The caution-needed IP address estimation device according to the first item,

wherein the acquisition means acquires a name of the subject from mass media information, and acquires the IP address from a website name that corresponds to this name.

### (Third Item)

The caution-needed IP address estimation device according to the first or second item,

wherein the acquisition means determines the degree of exposure based on the number of times the subject has appeared in the mass media.

### (Fourth Item)

A monitoring system including: the caution-needed IP address estimation device according to any one of the first to third items; the NW monitoring information database device; and a network security monitoring device attached to a packet forwarding device.

### (Fifth Item)

The monitoring system according to the fourth item,

wherein the NW monitoring information database device is configured to transmit, to the network security monitoring device, NW security monitoring information that includes the caution-needed IP address and security measure information.

### (Sixth Item)

A caution-needed IP address providing method that is executed by a computer, including:

an acquisition step of acquiring, based on a degree of exposure of a subject covered by mass media, an IP address that is associated with the subject, the IP address serving as a caution-needed IP address; and

a transmission step of transmitting the caution-needed IP address to a NW monitoring information database device.

### (Seventh Item)

A program for causing a computer to function as the means of the caution-needed IP address estimation device according to any one of the first to third items.

The present embodiment has been described, but the present invention is not limited to the above-described specific embodiment. Various modifications and changes are possible without departing within the scope of the spirit of the present invention defined by the claim.

### REFERENCE SIGNS LIST

100 Caution-needed IP address estimation device
110 Information acquisition unit
120 Caution-needed subject determination unit
130 Website name acquisition unit
140 IP address acquisition unit
150 Caution-needed IP address list providing unit
200 Company/organization name DB
300 Website DB
400 IP address DB
500 NW monitoring information DB
600 Network device configuration DB
700 Network security monitoring device
1000 Drive device
1002 Auxiliary storage device
1003 Memory device
1004 CPU
1005 Interface device
1006 Display device
1007 Input device

1. A caution-needed IP address estimation device comprising:
an acquisition unit, including one or more processors, configured to acquire, based on a degree of exposure of a subject covered by mass media, an IP address that is associated with the subject, the IP address serving as a caution-needed IP address; and a transmission unit, including one or more processors, configured to transmit the caution-needed IP address to a NW monitoring information database device.

2. The caution-needed IP address estimation device according to claim 1, wherein the acquisition unit is configured to acquire a name of the subject from mass media information, and acquires acquire the IP address from a website name that corresponds to this name.

3. The caution-needed IP address estimation device according to claim 1, wherein the acquisition unit is configured to determine the degree of exposure based on the number of times the subject has appeared in the mass media.

4. A monitoring system comprising: the caution-needed IP address estimation device according to claim 1; the NW monitoring information database device; and a network security monitoring device attached to a packet forwarding device.

5. The monitoring system according to claim 4, wherein the NW monitoring information database device is configured to transmit, to the network security monitoring device, NW security monitoring information that includes the caution-needed IP address and security measure information.

6. A caution-needed IP address providing method that is executed by a computer, the method comprising: an acquisition step of acquiring, based on a degree of exposure of a subject covered by mass media, an IP address that is associated with the subject, the IP address serving as a caution-needed IP address; and a transmission step of transmitting the caution-needed IP address to a NW monitoring information database device.

7. A non-transitory computer readable medium storing a program for causing a computer to perform: an acquisition step of acquiring, based on a degree of exposure of a subject covered by mass media, an IP address that is associated with the subject, the IP address serving as a caution-needed IP address; and a transmission step of transmitting the caution-needed IP address to a NW monitoring information database device.

8. The non-transitory computer readable medium according to claim 7, wherein the acquisition step includes acquiring a name of the subject from mass media information, and acquiring the IP address from a website name that corresponds to this name.

9. The caution-needed IP address providing method according to claim 6, wherein the acquisition step includes determining the degree of exposure based on the number of times the subject has appeared in the mass media.

10. The caution-needed IP address providing method according to claim 6, wherein the acquisition step includes acquiring a name of the subject from mass media information, and acquiring the IP address from a website name that corresponds to this name.

11. The non-transitory computer readable medium according to claim 7, wherein the acquisition step includes determining the degree of exposure based on the number of times the subject has appeared in the mass media.
